(19) United States
(12) Patent Application Publication
(10) Pub. No.: US 2016/0179364 A1
(43) Pub. Date: Jun. 23, 2016

(54) DISAMBIGUATING INK STROKES AND GESTURE INPUTS

(71) Applicant: Lenovo (Singapore) Pte. Ltd., Singapore (SG)

(72) Inventors: John Weldon Nicholson, Cary, NC (US); Jianbang Zhang, Cary, NC (US); David Schwarz, Morrisville, NC (US); Sarah Jane E Cox, Raleigh, NC (US)

(21) Appl. No.: 14/580,880

(22) Filed: Dec. 23, 2014

(51) Int. Cl. G06F 3/0488; G06K 9/00

(52) U.S. Cl. CPC G06F 3/04883; G06K 9/00416

(57) ABSTRACT

One embodiment provides a method, including: accepting an ink stroke provided to an input application; determining a characteristic associated with the ink stroke; converting the ink stroke input into a gesture command based on the characteristic; selecting a gesture control based on a shape of the ink stroke; and committing at least one action based on the converting. Other embodiments are described and claimed.

### BACKGROUND

Information handling devices (“devices”), for example cell phones, smart phones, tablet devices, laptop computers, and the like permit users to input handwriting using a finger or pen/stylus. This allows users to write more naturally and without the use of a keyboard.

Conventionally a handwriting field, box or pane is presented to the user as an overlay, e.g., a rectangle in a lower portion of a touch screen display. In this area the user may provide input handwriting strokes, e.g., letters, numbers, characters, symbols, etc. The device employs software that uses the input handwriting strokes, which are generally presented on screen to provide visual feedback to the user, as input by converting the handwriting stroke input locations on the touch screen into machine text according to the language setting of the device. Alternatively, a graphic or image of unconverted handwriting input may be placed into an underlying application, e.g., an image of the user's signature.

When writing using such an application, it is often the case that the drawing, writing, or inking application provides shortcut facilities for the user to enter commands “from the pen,” such as “select,” “delete,” or “insert space,” to name just a few. These may be implemented as gesture commands that the user performs by writing in the application window.

### BRIEF SUMMARY

In summary, one aspect provides a method, comprising: accepting an ink stroke provided to an input application; determining a characteristic associated with the ink stroke; converting the ink stroke input into a gesture command based on the characteristic; selecting a gesture control based on a shape of the ink stroke; and committing at least one action based on the converting.

Another aspect provides an electronic device, comprising: an input and display device; a processor operatively coupled to the input and display device; and a memory that stores instructions executable by the processor to: accept an ink stroke provided to an input application; determine a characteristic associated with the ink stroke; convert the ink stroke input into a gesture command based on the characteristic; select a gesture control based on a shape of the ink stroke; and commit at least one action based on the converting.

A further aspect provides a product, comprising: a storage device having code stored therewith, the code being executable by a processor of an electronic device and comprising: code that accepts an ink stroke provided to an input application; code that determines a characteristic associated with the ink stroke; code that converts the ink stroke input into a gesture command based on the characteristic; code that selects a gesture control based on a shape of the ink stroke; and code that commits at least one action based on the converting.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3(A-D) illustrates an example input overlay application for disambiguating handwriting strokes from gestures.

FIG. 4 illustrates an example method of disambiguating gesture and ink strokes.

FIG. 5 illustrates example gesture inputs for editing ink strokes.

FIG. 6 illustrates example gesture inputs for editing existing typeset.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As described herein, a handwriting application's input field or overlay may be used to input both writing (e.g., for conversion to machine text or input as a graphic) and gestures (with associated functionality, e.g., insert, select, delete, etc.). This brings up a technical problem for the system in that it must be determined whether the input into the application field or overlay (window) should be considered normal ink input (e.g., ink strokes forming handwritten characters, drawings, symbols, etc.) or a gesture command (i.e., gesture inputs for executing associated functionality).

Gesture inputs may be enabled by a particular application, but not disambiguated easily from ink inputs. Therefore, when writing within an application that permits gestures, an “i” input, for example, often has the vertical line interpreted as a “line” gesture or the dot interpreted as a tap gesture. This may not be what the user intended, i.e., the user may have simply intended to input the written letter “i” as the input.

Accordingly, an embodiment provides a more user friendly and intuitive disambiguation functionality that does not require additional hardware (i.e., pen or stylus). Thus, an embodiment permits a user to provide inputs, e.g., using a finger tip or any type pen/stylus implements (active or passive), that are interpreted by the system as either gesture inputs or ink inputs (which include handwriting, drawing and graphic inputs, etc).

By way of specific example, an embodiment provides ink and gesture disambiguation by interpreting a user that “holds the stroke” is indicating to the system that the current stroke is to be interpreted as a gesture. After the user holds the stroke (e.g., moves less than a specified distance for a specified period of time following an ink stroke input), an embodiment sends the ink stroke points to a gesture recognizer component. The ink stroke itself may be used along with the holding input in order to identify a gesture command. For example, the ink stroke may be required to have at least specified length or shape, etc. to be recognized as a gesture generally, and the specific shape, timing of the stroke(s), etc., may be used to associate the input with a gesture command.

In an embodiment, gestures may be disabled and only enabled by some modal switch, either in the application, operating system, or hardware, such as a barrel button on the stylus. Using such a technique requires either a control key press (e.g., gesture input soft key, mechanical key, combinations thereof, etc.) or additional hardware (e.g., pen input button).

If a gesture input is determined, an embodiment may change the presentation of the ink stroke. For example, an embodiment may convert the ink stroke to a gesture input by clearing an initial visual feedback of the ink stroke on screen, as it is being interpreted as a gesture input. When a gesture recognizer component returns a gesture recognition result, an embodiment furthermore may indicate to the user the recognition result. For example, a line through ink stroke (crossing other previously entered characters), if held at the end by the user, may be input to a gesture recognition engine and interpreted as a “strikethrough” gesture. An embodiment may indicate this to the user by displaying the gesture's associated function, e.g., in a window or feedback bubble, as further described herein.

If the user “completes the stroke,” e.g., by lifting the touch point at the end of the line through ink stroke within a predetermined time, the gesture command may be executed, e.g., the characters lined through may be deleted. However, if the user moves (e.g., more than a specified distance in a specified time), the gesture command may be canceled and the ink stroke points may either go back to being considered as ink input or can be removed completely. As such, an embodiment also grants an implicit confirm/reject mechanism into the gesture command facility.

The illustrated example embodiments will be best understood by reference to the figures. The following description is intended only by way of example, and simply illustrates certain example embodiments.

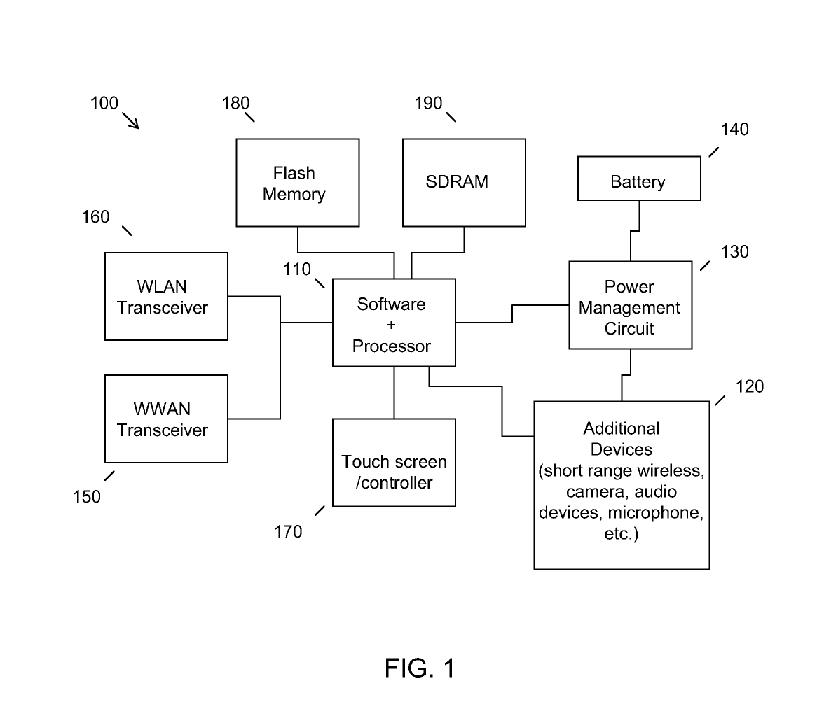

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additional devices 120 are commonly included, e.g., a camera, short range wireless devices, a microphone, etc. System 100 often includes a touch screen 170 for data input and display/rendering. System 100 also typically includes various memory devices, for example flash memory 180 and SDRAM 190.

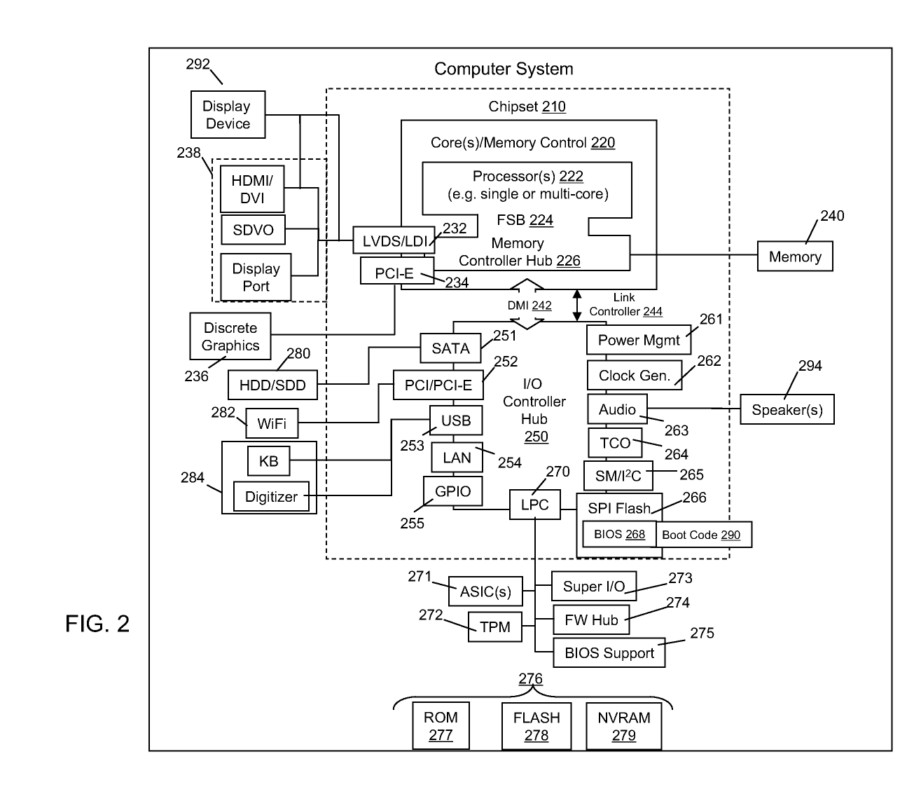

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries.

The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or other electronic devices. Users may employ these devices for various functions, e.g., inputting handwriting strokes as an input modality to an internet search application, an email application, a text messaging or instant messaging application, an e-signature application, inputting handwriting strokes to fillable forms, a drawing application, etc. For example, the circuitry outlined in FIG. 1 may be implemented in a tablet or smart phone embodiment, whereas the circuitry outlined in FIG. 2 may be implemented in a laptop personal computer embodiment. In each case, the device may include an input and display device, e.g., a touch screen or the like, which acts to accept ink strokes and provides visual displays of input characters, as well as components to convert handwritten characters or strokes into machine text, input strokes as graphics or images, convert ink strokes to gesture commands, and the like.

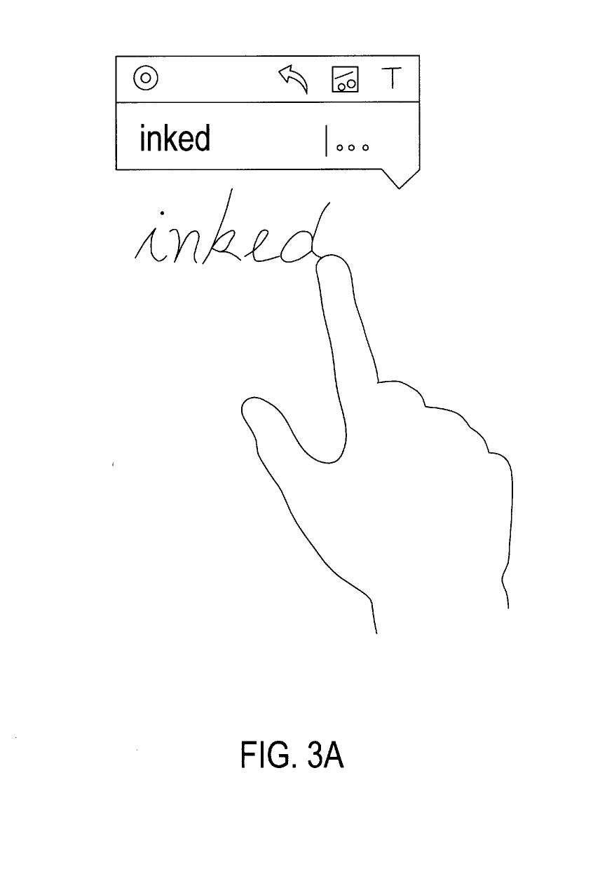

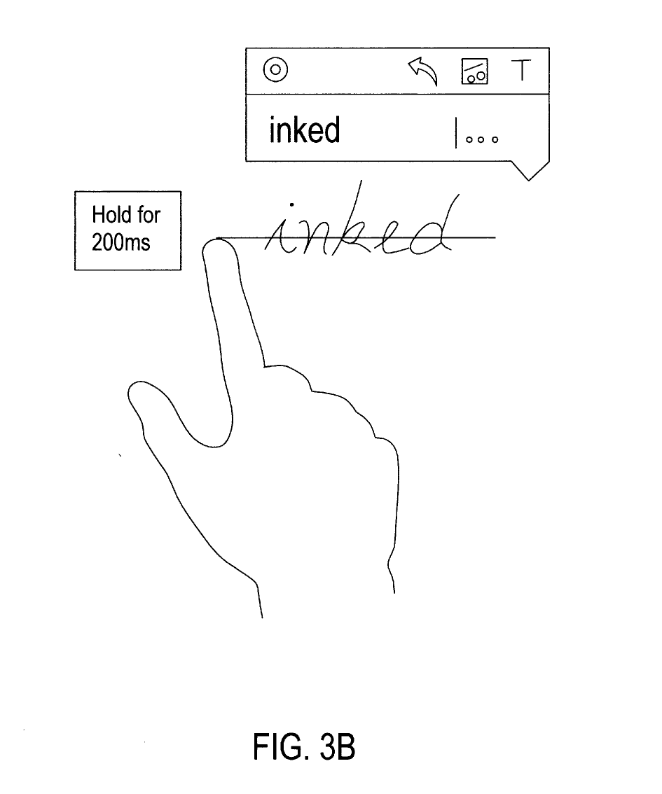

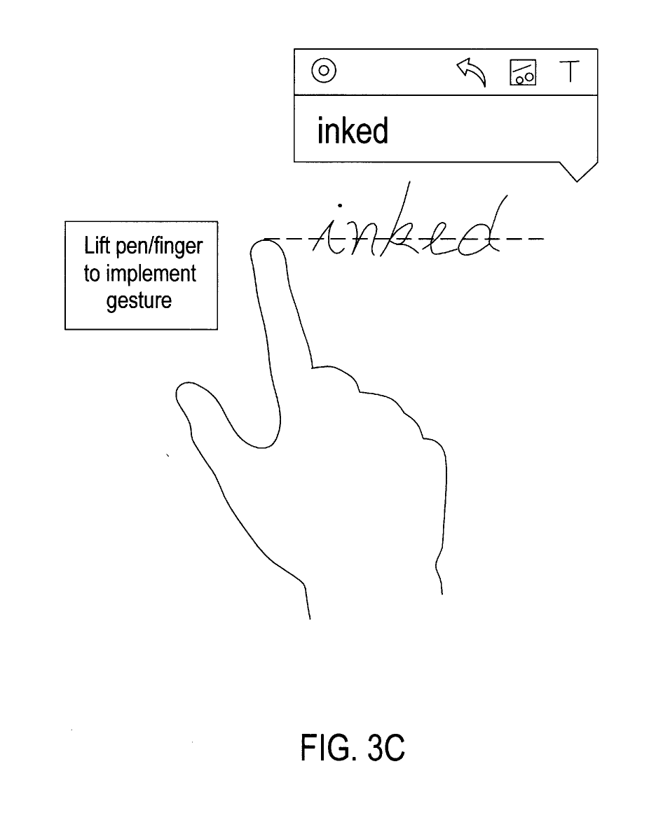

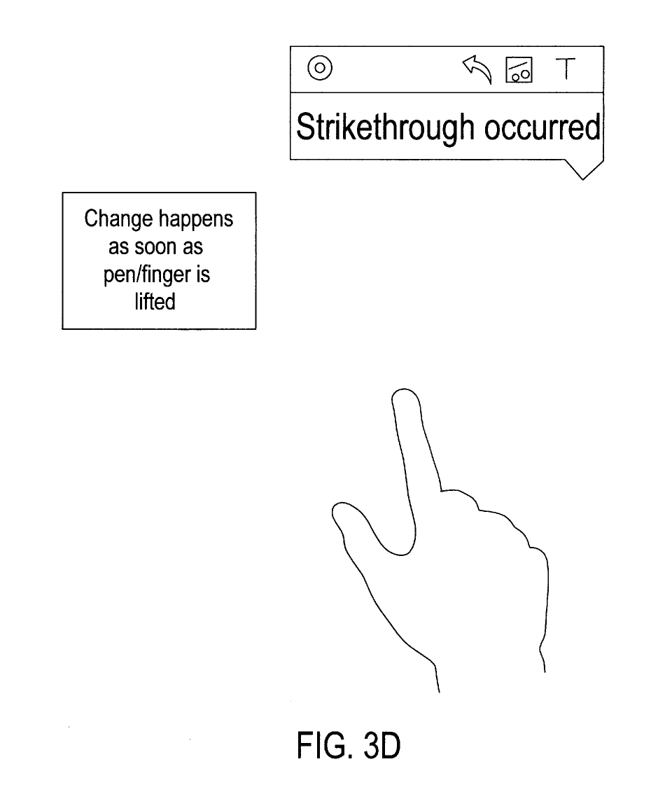

Referring now to FIG. 3A, by way of example, a user may provide ink strokes in the form of handwriting input, e.g., “inked” written in cursive script in this non-limiting example. An embodiment provides a user overlay application, e.g., presented on a touch screen of an electronic device such as a tablet or smart phone.

The overlay application accepts touch inputs, here represented by finger input (although pen/stylus input may be accepted as well), such that the user may provide handwriting on the screen. The ink strokes here may appear as characters, i.e., “i” and “n” and “k” and so on. If a user inputs a line ink stroke, for example the illustrated horizontal line ink stroke shown in FIG. 3B, the system may recognize this as a line through gesture or as a dash or hyphen character. As such, an embodiment permits a user to disambiguate the ink stroke input using an in-line mechanism.

As illustrated in FIG. 3B, if the user holds the line ink stroke, e.g., for 200 ms (or some predetermined time) without moving or lifting off the touch screen, i.e., a press and hold action at the end of the line ink stroke, an embodiment may be programmed to interpret this as a characteristic of the ink stroke input by which it may determine a gesture control is being input. That is, the press and hold serves as a signal to the input overlay application that the user desires a gesture function to be executed, associated with the ink stroke input, rather than the inputting of a horizontal line, i.e., a strike through editing mark presented in the text or graphic input to the underlying application.

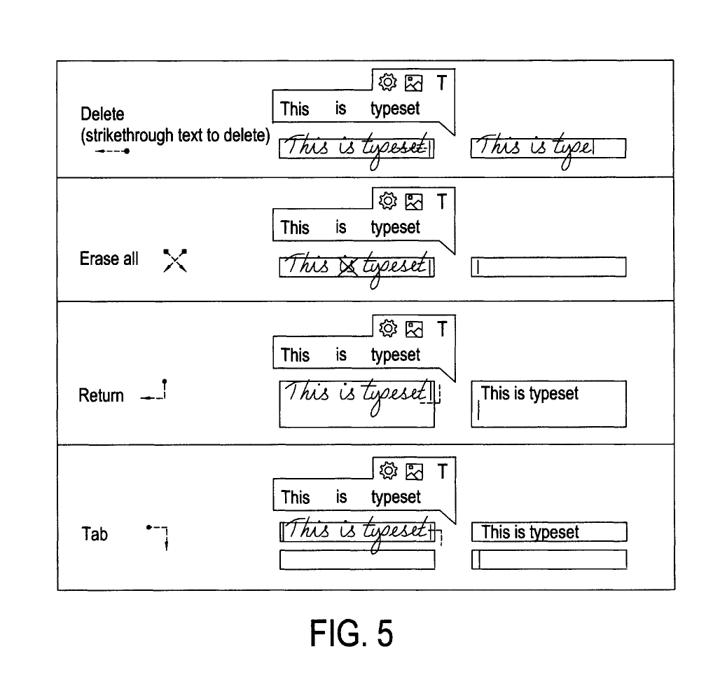

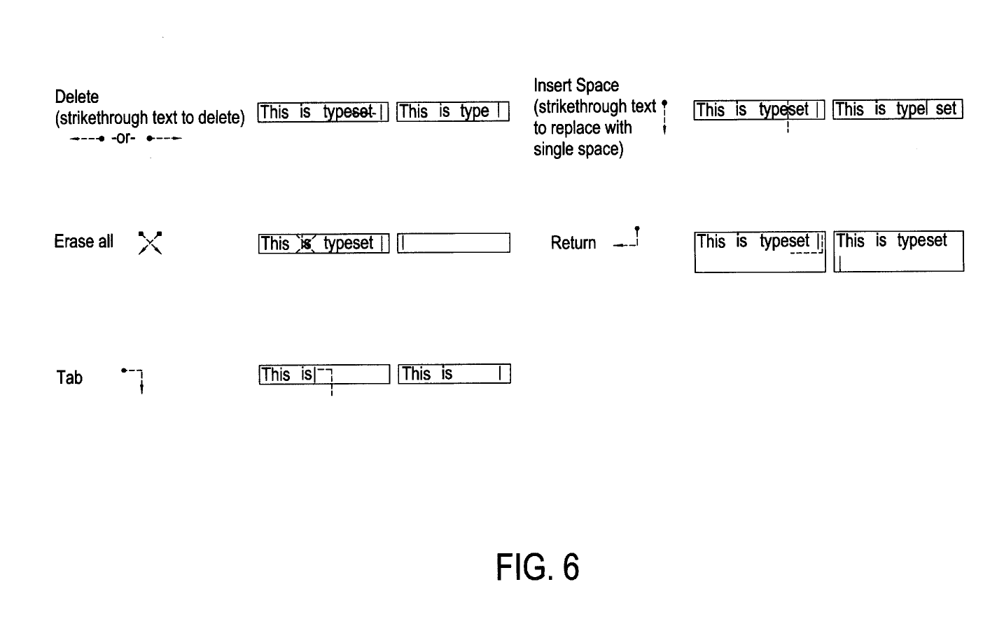

As may be appreciated, a variety of input techniques may be used to implement such in-line gesture controls. For example, an embodiment may be programmed to detect a press and hold at the beginning of an ink stroke, at both the beginning and the end of an ink stroke, etc. Moreover, although a line through or strike through ink stroke is indicated by way of example in FIG. 3 (A-D), other ink strokes may be associated with other gesture functionality. By way of non-limiting example, along with a hold of the stroke (e.g., pausing at the end of the ink stroke), a user may input a vertical line ink stroke (|)to insert a space, a user may input a shaped ink stroke such as (┐) to tab within text, a user may input another shaped ink stroke such as (┘) to perform a carriage return action, a user may input an (X) shaped ink stroke to delete a block of text (e.g., a paragraph, all text in a document, etc.), a user may provide editing ink strokes such as (̂) to insert text, etc. Thus, various shaped ink strokes, some of which are illustrated in FIG. 5, may be associated with gesture commands, such as undo, re-do, etc. A user may also use gestures, e.g., as disambiguated from substantive ink input, for editing existing typeset as well, as outlined in the examples illustrated in FIG. 6.

An embodiment may, after detecting a gesture input control is desired, e.g., by detecting a press and hold at the end of the ink stroke (or like mechanism), automatically commit an action associated with the gesture functionality. Thus, in the illustrated example of strike through, an embodiment may automatically erase the previous input strokes associated with the detected gesture. For example, as illustrated in FIG. 3D, an embodiment may delete or erase the ink strokes “inked” that were lined through with the line through gesture ink stroke that was held at the end by the user.

However, as illustrated in FIG. 3C, an embodiment may await confirmation from the user. As illustrated an embodiment may pause or delay the implementation of an associated gesture action or control until the user lifts his or her finger off of the touch screen or provides some other confirmatory input action. Likewise, an embodiment may clear a gesture control or functionality associated with a detected gesture, e.g., if the user instead of lifting the finger leaves the finger in place for more than a predetermined time, starts moving the finger again without lifting, etc.

Thus, as illustrated in FIG. 3D, an embodiment may implement a detected gesture control responsive to providing a user the opportunity to confirm the gesture.

This may or may not be coupled to providing a notification (e.g., visual identification) of the gesture functionality or control that will result, e.g., with lifting of the finger. The notification may be incorporated into a visual display, such as box or balloon type window or other on screen message. If the user does lift his or her finger, e.g., within a predetermined time and/or without providing further input movement, an embodiment may clear the lined through characters, in this example “inked.”

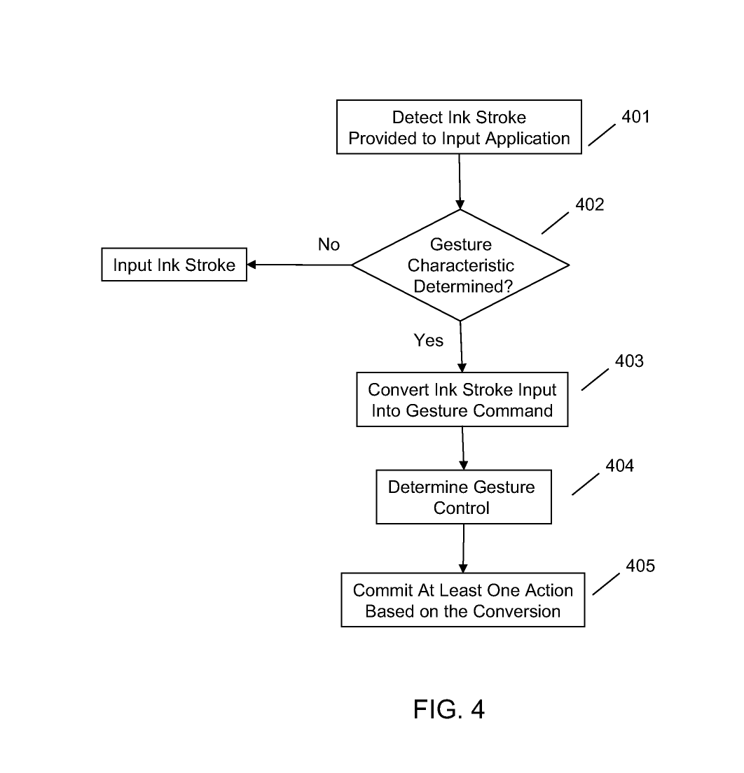

An embodiment therefore provides a convenient method of disambiguating gestures from normal ink strokes, whether provided by a finger tip or a pen/stylus. Referring to FIG. 4, an embodiment detects an ink stroke provided to an input application at 401 and determines, e.g., during the inputting of the ink stroke, a characteristic of the ink stroke associated with a gesture input at 402. As described herein, the characteristic may be a press and hold input, e.g., at the end of the ink stroke. If no such characteristic is detected, an embodiment may simply treat the ink stroke as ink input rather than an attempted gesture control.

If an ink stroke is input and a gesture characteristic is detected, as determined at 402, an embodiment may thereafter convert the ink stroke input into a gesture control at 403. By way of example, rather than (or in addition to) inserting the ink stroke into an underlying application, an embodiment uses the characteristic to convert the ink stroke into a request for gesture command. Thus, the ink stroke points may be submitted to a gesture recognition engine for processing. The gesture recognition engine may determine a gesture control at 404, e.g., based on a shape of the ink stroke, its association with one or more other input ink strokes, its timing or context of input, etc. This permits an embodiment to commit at least one action based on the converting at 405. That is, an embodiment may determine a gesture control or functionality associated with the ink stroke shape, etc.

By way of further example, the action may include executing a gesture function or control associated with the gesture command determined based on a shape of the ink stroke, e.g., deletion of lined through characters, insertion of whitespace, insertion of content in a given location, performing an undo action, etc. The action may include presenting a notification of the gesture command determined based on a shape of the ink stroke to the user, e.g., before or after the gesture functionality is processed. The action may include pausing a predetermined time prior to executing a gesture function associated with the gesture command determined based on a shape of the ink stroke, e.g., to allow for user confirmation or receiving of a clearing input for a gesture.

If the gesture is cleared, an embodiment may of course input the ink stroke into an underlying application. This may include conversion of the ink stroke to machine input (typeset) prior to inputting the ink stroke into the underlying application or simply inputting the ink stroke as a picture or a graphic.

The various embodiments described herein thus represent a technical improvement to ink stroke applications in that the applications are improved in their ability to disambiguate ink stroke input from gesture input. Using the techniques described herein, a user is permitted to provide disambiguating input in-line such that convenient and intuitive switching between ink input and gesture control is possible.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions that are executed by a processor and stored on a device readable storage medium, referred to herein as a non-signal storage device. A non-signal storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a non-signal storage device is not a signal, is non-transitory, and “non-transitory” includes all media except signal media.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a special purpose information handling device or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
accepting an ink stroke provided to an input application;
determining a characteristic associated with the ink stroke;
converting the ink stroke input into a gesture command based on the characteristic;
selecting a gesture control based on a shape of the ink stroke; and
committing at least one action based on the converting.

2. The method of claim 1, wherein the characteristic comprises a hold of a part of the ink stroke.

3. The method of claim 1, wherein the characteristic comprises a button press.

4. The method of claim 1, wherein the characteristic comprises a key press.

5. The method of claim 2, wherein the part of the ink stroke comprises an end of the ink stroke.

6. The method of claim 1, wherein the at least one action comprises executing a gesture function associated with the gesture control determined based on a shape of the ink stroke.

7. The method of claim 1, wherein the at least one action comprises presenting a notification of the gesture control determined based on a shape of the ink stroke.

8. The method of claim 1, wherein the at least one action comprises pausing a predetermined time prior to executing a gesture function associated with the gesture control determined based on a shape of the ink stroke.

9. The method of claim 1, further comprising receiving a clearing input for a gesture;
wherein the at least one action comprises clearing the gesture control determined based on a shape of the ink stroke.

10. The method of claim 8, further comprising converting the ink stroke into machine input and inputting the machine input into an underlying application.

11. An electronic device, comprising:
an input and display device;
a processor operatively coupled to the input and display device; and
a memory that stores instructions executable by the processor to:
accept an ink stroke provided to an input application;
determine a characteristic associated with the ink stroke;
convert the ink stroke input into a gesture command based on the characteristic;
select a gesture control based on a shape of the ink stroke; and
commit at least one action based on the converting.

12. The electronic device of claim 11, wherein the characteristic comprises a hold of a part of the ink stroke.

13. The electronic device of claim 11, wherein the characteristic comprises a button press.

14. The electronic device of claim 11, wherein the characteristic comprises a key press.

15. The electronic device of claim 12, wherein the part of the ink stroke comprises an end of the ink stroke.

16. The electronic device of claim 11, wherein the at least one action comprises executing a gesture function associated with the gesture control determined based on a shape of the ink stroke.

17. The electronic device of claim 11, wherein the at least one action comprises presenting a notification of the gesture control determined based on a shape of the ink stroke.

18. The electronic device of claim 11, wherein the at least one action comprises pausing a predetermined time prior to executing a gesture function associated with the gesture control determined based on a shape of the ink stroke.

19. The electronic device of claim 11, wherein the instructions are further executable by the processor to receive a clearing input for a gesture;
wherein the at least one action comprises clearing the gesture control determined based on a shape of the ink stroke.

20. A product, comprising:
a storage device having code stored therewith, the code being executable by a processor of an electronic device and comprising:
code that accepts an ink stroke provided to an input application;
code that determines a characteristic associated with the ink stroke;
code that converts the ink stroke input into a gesture command based on the characteristic;
code that selects a gesture control based on a shape of the ink stroke; and
code that commits at least one action based on the converting.
